(19) United States
(12) Patent Application Publication
(10) Pub. No.: US 2017/0294695 A1
(43) Pub. Date: Oct. 12, 2017

(54) Stall Delay Power Surge Protector

(71) Applicant: Robert M. Lumpkins, Ashbury Park, NJ (US)

(72) Inventor: Robert M. Lumpkins, Ashbury Park, NJ (US)

(73) Assignee: Mrs. Deborah A. Lumpkins, Bowie, MD (US)

(21) Appl. No.: 15/530,045

(22) Filed: Dec. 12, 2014

(51) Int. Cl. H01M 10/655

(52) U.S. Cl. CPC H01M 10/655; H01M 10/625

(57) ABSTRACT

The stall delay power surge protector is a copper terminal strip that is designed to increase the life of any battery, voltage regulator or starter by acting as a surge protector or a heat sink that dissipates heat only for electrical current. The stall delay power surge protector would be attached and fused into a battery cable that leads to the battery on one end and attached and fused to an electrical wire leading to the voltage regulator or starter on the opposite end of the stall delay power surge protector, thus requiring no direct connection of the stall delay power surge protector to the battery, voltage regulator or starter of any car, boat, motorcycle, riding lawn mower, tractor, truck or RV.

### BRIEF DESCRIPTION OF DRAWINGS

FIG. 1 is a perspective view of a rubber-coated copper plate for preventing electrical spike surges to an alternator regulator, generator, starter and/or battery from breaking down showing my new design:

FIG. 2 is a front elevational view of the rubber-coated copper plate.

FIG. 3 is a rear elevational view of the rubber-coated copper plate.

FIG. 4 is a top plan view of the rubber-coated copper plate.

FIG. 5 is a bottom plan view of the rubber-coated copper plate.

FIG. 6 is a left side elevational view of the rubber-coated copper plate.

FIG. 7 is a right side elevational view of the rubber-coated copper plate.

### DETAILED DESCRIPTION

A stall delay attachment unit would be an electrical attachment made from non-corrosive copper metal and covered with a weather-proof casing or coating to prevent shock. The stall delay attachment unit would be a flat, rectangular terminal strip which would have dimensions of 2 inches (in.) in length, 0.5 inches (in.) in width, and 0.25 inches (in.) in thickness. Before installing the Stall Delay Attachment unit, an existing wire connected between a voltage regulator and a battery or starter would be cut at a desired location to fuse in the copper wires leading from each opposite end of the stall delay attachment unit.

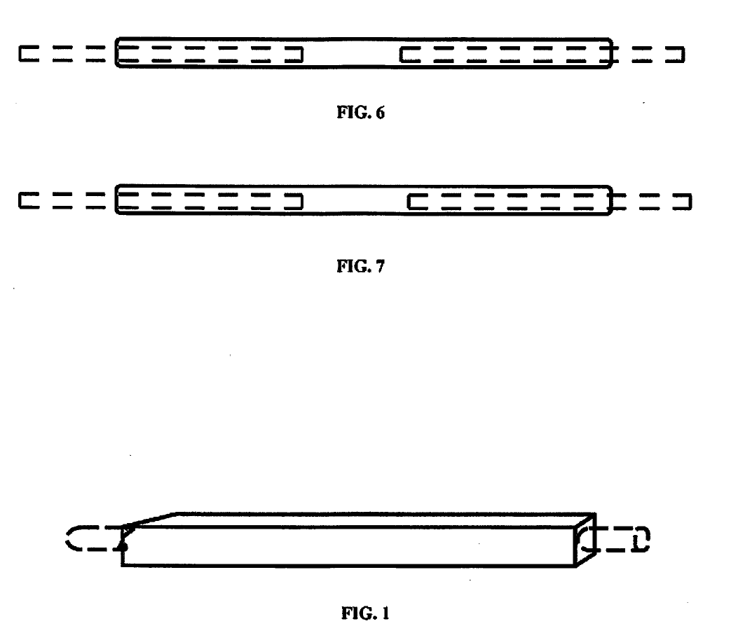

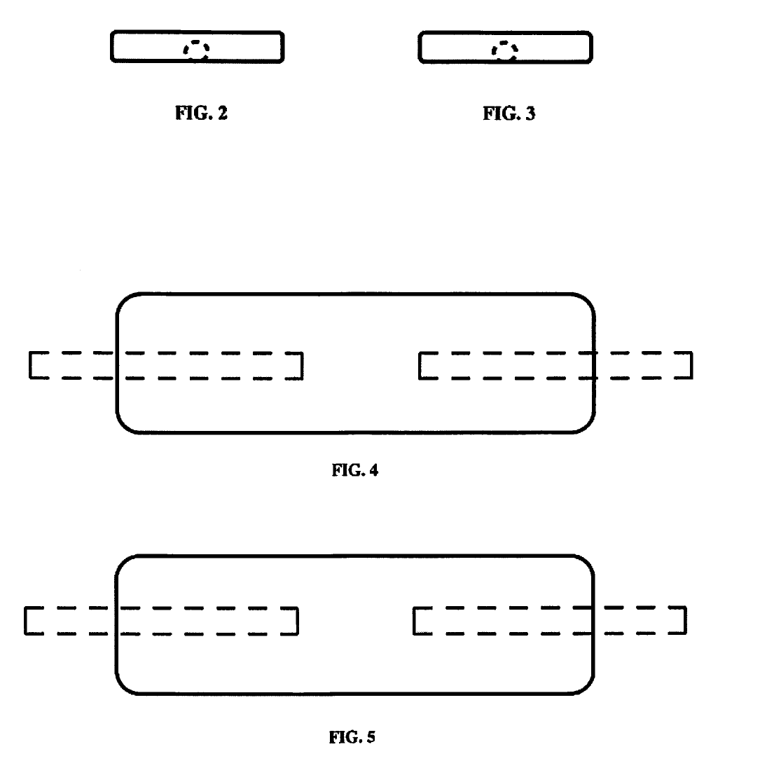

The broken lines shown in FIGS. 1-7 represent infused internal/external copper wire.

What is claimed is:

1. The ornament design for a rubber coated copper plate for preventing electrical spike surges to any alternator, regulator, generator or battery from breaking down.
